(19) United States
(12) Patent Application Publication
(10) Pub. No.: US 2006/0208379 A1
(43) Pub. Date: Sep. 21, 2006

(54) Rotary apparatus for forming decouplers for vehicle interior components

(76) Inventors: Surendra Khambete, West Bloomfield, MI (US); William Griffin, Indian Trial, NC (US); Fred Skidmore, Marion, NC (US); Sandrip Mehta, Canton, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/224,727

(22) Filed: Sep. 12, 2005

Related U.S. Application Data
(63) Continuation of application No. PCT/US04/07575, filed on Mar. 12, 2004.
(63) Continuation of application No. 10/776,015, filed on Feb. 10, 2004.
(60) Provisional application No. 60/454,203, filed on Mar. 12, 2003.

(51) Int. Cl. B29C 39/00

(52) U.S. Cl. 264/46.8

(57) ABSTRACT

A method of manufacturing an article having controlled density, such as a decoupler for a vehicle interior trim component, is disclosed which uses an indexing, preferably rotary, apparatus. The method comprises the conveying of materials, preferably fibers, into an enclosure to form a preform having a shape of the enclosure, transferring the preform to a mold on an indexing apparatus where the preform is heated to a temperature such that adjacent fibers bond to one another upon cooling, and moving the mold to a press where the heated preform is molded into a predetermined three-dimensional decoupler configuration. The enclosure has a perforated portion and at least one panel movable relative to the enclosure so as to selectively expose portions of the perforated portion. The density of the preform may be varied as the at least one panel is removed to expose the perforated portion of the enclosure.

### CROSS REFERENCE TO RELATED APPLICATIONS

This application is a Continuation of International Application No. PCT/US04/007575 filed Mar. 12, 2004 and published Sep. 23, 2004 as International Publication No. WO 2004/080763, designating the United States, and which claims priority to U.S. patent application Ser. No. 10/776,015 filed Feb. 10, 2004 (now abandoned) and claims the benefit of U.S. Provisional Application Ser. No. 60/454,203 filed Mar. 12, 2003, the teachings of which are incorporated by reference.

### TECHNICAL FIELD

The present invention relates generally to trim components for vehicles, particularly to noise attenuation in vehicles as provided by those components, and, more particularly, to an indexing method and apparatus for forming those components.

### BACKGROUND OF THE INVENTION

It is generally considered desirable to reduce the level of noise within a vehicle passenger compartment. External noises, such as road noise, engine noise, vibrations, etc., as well as noises emanating from within passenger compartments, may be attenuated through the use of various acoustical materials. Accordingly, sound attenuating materials for vehicles, such as automobiles, are conventionally used in the dashboard, in conjunction with carpeting for floor panels, in the wheel wells, in the trunk compartment, under the hood, and as part of the headliner.

Recently, a lot of emphasis has been placed on the acoustic properties of vehicle trim components, such as carpeting and dash insulators, because of customer requirements for quieter passenger compartments. Carpeting used to cover the floor areas of vehicles, such as automobiles, is conventionally molded into a non-planar three dimensional contoured configuration which conforms to the contours of the vehicle floor so as to fit properly. Dash insulators are mounted to a vehicle firewall which separates the passenger compartment from an engine compartment. Dash insulators are designed to reduce the transmission of noise and heat from the engine compartment into the passenger compartment. Package trays and trunk trim may be used to reduce the noise entering the passenger area of a vehicle.

A foam or fibrous layer of material referred to as a decoupler is typically attached to the backside of vehicle dash insulators and carpeting to absorb sound. The decoupler may act as an isolator between adjoining layers. The decoupler and interior trim component are usually supplied for installation into the vehicle separately, but may be combined during manufacturing so that a single product may be installed in the vehicle, further saving labor and transportation costs. Decouplers may be required to have complex shapes and configurations and, as such, may be time-consuming and expensive to manufacture. Vehicle manufacturers are constantly looking for ways to reduce costs and complexity associated with vehicle manufacturing. Moreover, vehicle manufacturers are constantly looking for ways to reduce noise within passenger compartments while reducing weight of trim components. Accordingly, there is a need for acoustical insulation materials for use within vehicles that exhibit superior sound attenuating properties, while also being lightweight and low in cost and which further may be tailored to fit complex geometries within the vehicle and have sound attenuation characteristics that may be tailored to those geometries.

U.S. Provisional Application Ser. No. 60/454,203, filed Mar. 12, 2003 and assigned to the assignee of the present invention is directed at a method and apparatus for forming articles having controlled density, such as decouplers, wherein fibers are conveyed into an enclosure to form a preform which is subsequently transferred to an oven for heating, then transferred to a mold for forming the finished decoupler shape using an, essentially, in-line apparatus.

U.S. application Ser. No. 10/775,547, filed Feb. 10, 2004, entitled “Improved Methods Of Forming Decouplers For Vehicle Interior Components”, and assigned to the assignee of the present invention is directed at a method and apparatus for forming articles having controlled density, such as decouplers, wherein materials are conveyed into an enclosure to form a preform which is subsequently transferred to an oven for heating, then transferred to a mold for forming the finished decoupler shape using an, essentially, in-line apparatus.

U.S. application Ser. No. 10/775,548, filed Feb. 10, 2004, entitled “Improved Methods Of Forming Vehicle Interior Components Which Include A Decoupler Layer”, and assigned to the assignee of the present invention is directed at the mating of an article having controlled density, such as a decoupler, to an interior trim component using an essentially similar in-line apparatus as above, and includes alternative means for heating the preform and interior trim component.

U.S. application Ser. No. 10/775,549, filed Feb. 10, 2004, entitled “Contoured Mold For Forming Decouplers For Attenuating sound In A Vehicle”, and assigned to the assignee of the present invention is directed at a contoured mold which may be used to create the preform, heat the preform and form the preform into a finished decoupler shape.

An alternate means, as described herein, for preparing decouplers and for mating decouplers to interior trim components includes an indexing apparatus wherein a series of molds may be conveyed by a rotary table, robot or like apparatus. The molds are indexed to specific locations or stations by rotation or indexing of the table or like apparatus such that at each index point or station, an operation is performed. This apparatus provides advantages by requiring less floor space then other layouts and the associated process is more amenable to smaller volume and shorter production runs wherein the tooling may be exchanged readily to provide different decoupler shapes.

### SUMMARY OF THE INVENTION

In view of the above, systems and methods of forming articles having controlled density, such as decouplers for attenuating noise in vehicles, using an indexing, preferably rotary, apparatus are provided. According to embodiments of the present invention, a method of manufacturing a decoupler for a vehicle interior trim component includes: ascertaining the acoustic properties of a portion of a vehicle passenger compartment to identify portions thereof requiring enhanced sound attenuation; conveying materials into an enclosure to form a preform having a desired shape and density profile; heating the preform to a temperature such that upon cooling adjacent materials bond to one another; and forming the heated preform into a predetermined three-dimensional decoupler configuration wherein a, preferably, rotary table indexes a series of molds to different stations for carrying out these steps. The predetermined configuration is based upon the physical dimensions of the vehicle in the area where the decoupler will be installed and the sound attenuation desired in that area. The mold for forming the decoupler of the present invention may have a contoured shape as well as sections which may be moved to adjust the thickness of the decoupler locally. Thus, both thickness and density of the decoupler may be adjusted to provide a range of sound attenuation.

According to embodiments of the present invention, an enclosure into which materials are conveyed has a perforated portion and one or more panels are movable relative to the enclosure so as to selectively expose portions of the perforated portion as materials are conveyed via an airstream into the enclosure to form a preform. The air exits the enclosure through the perforations, while the loose materials are collected in that area of the enclosure. The density of selected areas of the preform formed within the enclosure is controlled by the rate and/or duration at which the perforated portion of the enclosure is exposed. The density also may be a function of the pressure in the air stream which conveys the loose materials and the concentration of the materials in the air stream. According to embodiments of the present invention, the density of selected areas of the preform may be increased in areas identified as requiring enhanced sound attenuation. Thus, for each selected area of an interior trim component or decoupler identified as requiring enhanced sound attenuation, pressure may be increased along with the concentration of fibers conveyed, and/or the rate of movement of the panel is slowed, and/or the duration of exposure of the perforated portion is increased, so that more materials are conveyed into that particular area of the enclosure and collected to form a preform. Furthermore, the delivery of materials may be adjusted by controlling the opening diameter of the output section of the duct that provides the airflow to the mold, and such airflow may also be selectively pulsed or varied in rate to again control the amount of material collecting at a given location in the mold. In addition, a preform of varying cross section that is contoured may be formed and later compressed to provide additional densification and sound attenuation in specific areas.

Furthermore, the delivery of material may be adjusted by controlling the opening diameter of the output section of the duct that provides the airflow to the enclosure, and such airflow may also be selectively pulsed or varied in rate to again control the amount of material collecting at a given location in the enclosure.

Once the preform is formed to the desired shape and density, it is transferred to an indexing apparatus, preferably a rotary table, and into a perforated mold which contains the loose preform. The table then indexes to a heating station where heated air is supplied to heat the materials such that upon cooling, the materials may bond to one another. The table next indexes to a molding station where the mold is adjusted in height to form the final thickness and shape of the decoupler. The final station is a stripping station where the finished decoupler can be removed from the mold and essentially retain its shape. The mold may then index to the first station to receive the next preform for processing. Other indexing apparatus as known in the art, including but not limited to, shuttle tables, robots, mold manipulators and over-and-under lines may also be used to convey the preform from station to station.

According to embodiments of the present invention, the preform may also be formed of a contoured shape using a contoured enclosure and mold to provide different density profiles as well as different cross-sectional thickness in different areas of the preform, and the contoured shape may be compressed during molding to form a decoupler having a uniform or a non-uniform cross-section, allowing for a wide range of densities and thus impedances to be achieved.

According to embodiments of the present invention, the preform may be optionally combined with an interior trim component (e.g., dash insulator, carpeting, etc.) and heated and molded together to form a predetermined three-dimensional interior trim configuration, including a decoupler.

According to embodiments of the present invention, a method of manufacturing an article having a controlled density, preferably a preform or decoupler, includes filling an enclosure with material, e.g. thermoplastic material, thermoset material, fibrous material, foam, woven material, nonwoven material, fibers of any type, and combinations thereof. Preferably, blends of fibers may be utilized. For example, different denier fibers may be used at different locations to achieve different acoustical performance. In addition, fibers of different material compositions may be used, as well as fibers having multiple material compositions within the same fiber (for instance,. bicomponent fibers such as sheath/core, alternating segments, etc.) and blends thereof.

Reference to the conveying of “material” or “materials” should be understood to include the conveying of a single material, for instance in fiber form, or two or more materials either in fiber form or non-fibrous form. Furthermore, the materials used to fill the enclosure may be in nearly any form and shape, including but not limited to, fibers, clumps, chunks, tufts, beads, clusters, scraps, powder and pellets. The materials may also be of nearly any size and aspect ratio. In addition, it is preferably to control such size and aspect ratio such that they may be conveyed to the enclosure and retained in the enclosure by adjustment of the size of the openings in the perforated portions of the enclosure and to preferably provide an article with some degree of loft or reduced density.

Accordingly, the size and shape of the openings in the perforated portion of the enclosure may be selectively adjusted such that the materials having a variety of forms and shapes that are conveyed to the enclosure may be selectively collected in the enclosure to form a preform.

Decouplers according to embodiments of the present invention may be manufactured inexpensively and may replace expensive batting and other fibrous materials currently utilized in vehicles. Moreover, decouplers according to the present invention may utilize less material than conventional batting because material for sound absorption is strategically placed directly where it is needed providing a more efficient use of material. Thus, the combination of specific area density and localized part thickness are used to provide effective sound attenuation by selectively controlling density and decoupler thickness at any selected location. As such, decouplers according to the present invention may be lighter in weight when compared with conventional decouplers and may be provided with variable thickness without the stacking of multiple layers. Decouplers according to embodiments of the present invention may have different acoustical profiles in different locations to suit the specific needs of a vehicle. The decouplers disclosed herein therefore provide the opportunity to control costs by targeting, material preferably fiber, placement and cross-sectional thickness at selected locations while avoiding the need for more expensive components such as binder layers or other additives or multiple layers in the overall interior trim composition. In addition, it should be understood in the context of the present invention, and with respect to functionality, reference to a decoupler includes any media which acts as a sound absorber or sound barrier or sound isolator or sound insulator or sound attenuator, or combinations thereof. Accordingly a decoupler includes any media that may effect sound.

Decouplers formed by the process and apparatus of the present invention may be produced economically using an efficient layout of equipment which may also manufacture multiple shapes given the ability to make rapid changes to the associated tooling.

### BRIEF DESCRIPTION OF THE DRAWINGS

The accompanying drawings, which form a part of the specification, illustrate key embodiments of the present invention. The drawings and description together serve to fully explain the invention.

FIG. 1 is a flow chart of basic operations for manufacturing a decoupler, according to embodiments of the present invention.

FIG. 2 is a flow chart of a method for manufacturing decouplers, according to embodiments of the present invention.

FIG. 3 is a schematic illustration of a system for manufacturing decouplers, according to embodiments of the present invention.

FIG. 4 is an enlarged view of a portion of the enclosure, mold and preform of FIG. 3.

FIG. 5 is a perspective view of the duct that connects the blower and the enclosure of FIG. 3.

FIG. 6 is a side view of the enclosure of FIG. 3 into which fibers are blown to produce a preform, and that illustrates the movable panels overlying the perforated portion.

FIG. 7 is a top plan view of the enclosure of FIGS. 3 with the upper portion removed for clarity and illustrating a decoupler substantially formed therein.

FIGS. 8-12 illustrate various mold configurations for producing preforms and decouplers with sections having different densities (FIGS. 8-9), contoured performs and decouplers with different densities and similar crossection (FIGS. 10-11), and contoured preforms and decouplers with different densities and different cross-sectional dimensions (FIGS. 12).

FIG. 13 is a schematic diagram of the operation of a process controller used in the system of FIG. 3.

FIG. 14 is a flow chart describing the flow of information managed by the process controller of FIG. 3.

### DETAILED DESCRIPTION OF THE INVENTION

The present invention now is described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

In the drawings, the thickness of lines, layers and regions may be exaggerated for clarity. It will be understood that when an element such as a layer, region, substrate, or panel is referred to as being “on” another element, it can be directly on the other element or intervening elements may also be present. In contrast, when an element is referred to as being “directly on” another element, there are no intervening elements present. It will be understood that when an element is referred to as being “connected” or “attached” to another element, it can be directly connected or attached to the other element or intervening elements may also be present. In contrast, when an element is referred to as being “directly connected” or “directly attached” to another element, there are no intervening elements present. The terms “upwardly”, “downwardly”, “vertical”, “horizontal” and the like when used herein are for the purpose of explanation only.

For elements common to the various embodiments of the invention, the numerical reference character between the embodiments is held constant, but distinguished by the addition of an alphanumeric character to the existing numerical reference character. In other words, for example, an element referenced at 10 in the first embodiment is correspondingly referenced at 10A, 10B, and so forth in subsequent embodiments. Thus, where an embodiment description uses a reference character to refer to an element, the reference character applies equally, as distinguished be alphanumeric character, to the other embodiments where the element is common.

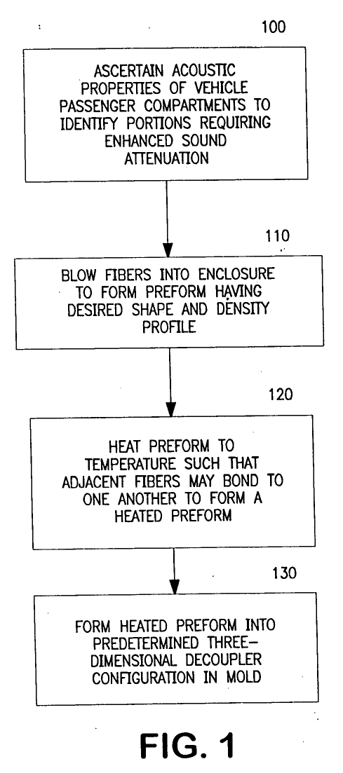

Referring now to FIG. 1, the basic operations for manufacturing a decoupler for a vehicle interior trim component, according to embodiments of the present invention, includes the steps of: ascertaining the acoustic properties of a portion of a vehicle passenger compartment to identify portions thereof requiring enhanced sound attenuation (Block 100); conveying materials, preferably fibers, into an enclosure to form a preform having a desired shape and density profile (Block 110); heating the preform to a temperature such that adjacent materials upon cooling bond to one another (Block 120); and forming the heated preform into a predetermined three-dimensional decoupler configuration via a mold (Block 130). Upon cooling of the three-dimensional decoupler configuration, the bonding of adjacent materials, preferably fibers, to one another provides shape retention of the predetermined configuration.

According to embodiments of the present invention, the various steps of the operations illustrated in FIG. 1 may be performed out of the illustrated order. For example, acoustic properties of one or more portions of a vehicle passenger compartment may be performed well in advance of the remaining steps of FIG. 1. Furthermore, operations represented by various blocks may be performed substantially simultaneously. For example, a preform may be heated and formed to shape (Blocks 120, 130) at substantially the same or different times.

As noted, the present invention relies in part upon the step of heating the preform to a temperature such that upon cooling adjacent material or the preferred fibers bond to one another. This may be accomplished by a variety of methods, one of which is heating the materials or fibers to a temperature such that adjacent materials or fibers bond to one another without melting. Elaborating on this concept, it can be appreciated that this is in reference to the feature of employing an amorphous polymer, as part of the material or fiber mix, wherein the amorphous polymer itself does not have a defined melting point (Tm) sufficient to soften as a consequence of a true thermodynamic melting event, and provide bonding. Instead, since the polymer is amorphous, the softening may occur at a secondary transition temperature, e.g. the glass transition temperature (Tg), or at some other temperature. Those of skill in the art will therefore appreciate that heating of, for instance fibers to a temperature such that the adjacent fibers bond to one another without melting may occur at a temperature above the Tg of a substantially amorphous polymer material within the fiber composition. Under such circumstances, the crystalline polymer fibers of the fiber mix remain non-melted, and the amorphous polymers heated at or above their Tg will provide the bonding necessary upon cooling.

Alternatively, it is contemplated that bonding may occur via the use of binders which themselves may be chemically reactive due to the introduction of heat. For example, one may optionally employ a binder system that includes a component, such as a polymeric precursor, which undergoes chemical crosslinking, as in the case of a thermoset type precursor. Alternatively, one may optionally elect to use a moisture cure system, wherein the component, such as a polymer resin, will, upon introduction of heat and moisture, react and solidify upon cooling to provide binding within the preform.

Furthermore, one may also use a non-reacting binder system, e.g., a urethane water dispersion which can be used to coat the fibers and which upon heating and evaporation of the water provides bonding of adjacent materials or fibers to form a preform. Again, this would be another example of material or fiber bonding without the fibers themselves melting.

In even further embodiment, one could also utilize a component binder, such as a polymer, with a melting point below the melting point of the material or fibers of the preform, which polymer binder could be applied to the material or fibers, say by spraying, which would experience melting at elevated temperature to cause bonding of adjacent materials or fibers within the preform when cooled. Again, this would be yet another example of material or fiber bonding without the materials or fibers of the preform themselves melting.

It can therefore now be noted that the acoustic properties of a portion of a vehicle passenger compartment may be ascertained by identifying areas of the passenger compartment where internal and external sounds have an intensity level that exceeds a threshold intensity level. This may include generating a sound intensity map of one or more portions of the passenger compartment. Sound intensity maps are well understood by those skilled in the art and need not be described further herein. For example, see “Noise Control: Measurement, Analysis and Control of Sound & Vibration”, Krieger Publishing Co., Malabar, Fla., 1994.

According to embodiments of the present invention, an enclosure into which materials, preferably fibers, are conveyed has a perforated portion and one or more panels that are moveable relative to the enclosure in any direction so as to selectively expose portions of the perforated portion as materials or fibers are conveyed into the enclosure. The air stream, or for that matter, any other suitable carrying media such as a gas or fluid conveying the materials or fibers, exits the enclosure through the perforated portion, allowing the materials or fibers to collect in that area. In such regard, it should be appreciated that one could also simply gravity feed the enclosure with the materials or fibers. For exemplary purposes only, air will be relied upon as a preferred media for conveying the preferred fibers.

Fiber or material density of a preform formed within the enclosure may therefore be preferably controlled by the rate at which the perforated portion of the enclosure is exposed (or that the panels are moved) and/or the duration for which the perforated portions are exposed. For example, an essentially uniform rate of panel movement exposing the perforated portion will provide a preform of essentially uniform density. Slowing or increasing the rate of removal of the panels allows the preform to be comprised of various sections having higher and/or lower material or fiber density. In addition, the rate at which materials or the preferred fibers may be fed to the enclosure from the blower also may affect the density of the preform. For example, should one introduce fibers at a relatively high rate (e.g. 40 lbs/min.) for a relatively long time, over a given perforation area, such would provide a more dense packing of fibers relative to a slower rate of fiber introduction (e.g. 10 lbs./min.) for a shorter period of time.

According to embodiments of the present invention, material or the preferred fiber density may be increased in areas of a decoupler identified as requiring enhanced sound attenuation. Thus, for each area of a decoupler identified as requiring enhanced sound attenuation, the pressure in the enclosure may be increased (or the rate of panel movement is decreased) as materials or fibers are blown into that particular area of the enclosure as the preform is being formed. Moreover, different types, sizes, composition and physical features of materials or fibers may be used at different locations of a decoupler. For example, it is contemplated that the feed mix of materials or fibers can be selectively adjusted at any given time during fill of the enclosure to vary the type of materials or fibers delivered at a selected location within the enclosure. For example, the more dense the selected areas of the decoupler are formed, and the finer the fibers, the higher the acoustic impedance. Furthermore, in the broad context of the present invention, the preform may be of contoured shape and compressed at selective levels during molding to further control and densify specific areas.

Preferably, fibers are conveyed into the enclosure by supplying loose fibers to an airstream emanating from an air blower. However, other means for conveying the fibers, including but not limited to, vacuum and combinations of vacuum and pressure may be used. Accordingly, it can also be appreciated that for a given three dimensional contoured shape, vacuum may be selectively applied at those locations for which fiber fill needs to be assisted beyond mere filling via air blowing. More specifically, for areas of a preform that are desirably of a higher density and greater thickness, one may prefer to utilize air pressure and vacuum to improve fiber fill.

Material or the preferred fibers may be blown and/or drawn into the enclosure from more than one direction. For example, fibers may be blown into the enclosure from multiple directions and/or from multiple ducts or nozzles. In addition, it is further contemplated that various types of materials or fibers may be conveyed into the enclosure selectively (e.g. specific fiber types supplied at each nozzle) through these ducts or nozzles to provide different preform compositions in selected areas of the preform. Further, specific nozzles or ducts may be selected at advantageous locations around the enclosure to deliver specific binder compositions of the types noted previously (e.g. amorphous fibers, reactive binders, low melting polymers, etc.).

As noted, various types and sizes of the preferred fibers may be utilized in accordance with embodiments of the present invention. For example, shoddy fibers may be utilized, as well as other scrap and non-scrap fibers of various lengths. Shoddy, being a mixture of various fibers, presents a unique opportunity to bond adjacent fibers together due to the varied properties of the fibers within the mixture. Preferably, as noted, the fibers are blown into the enclosure in a substantially loose state. The fibers may include, but are not limited to, synthetic fibers (thermoplastic and/or thermoset), natural fibers, recycled fibers and blends thereof. In addition, fibers having multiple compositions such as bicomponent fibers, including but not limited to, sheath/core, side-by-side, tipped, segmented pie, striped and islands-in-a-sea variants may be used, either alone, or in combination with synthetic and/or natural fibers. In the case of bicomponent fibers, as alluded above, one of the components is strategically utilized to provide bonding after a heating and cooling profile. In addition, such bonding may occur without melting of the fibers of the preform, as the bicomponent may contain one polymer component that is amorphous and which does not have a Tm. Preferably, such bicomponent fiber comprises a sheath/core construction, with an inner core of crystalline poly(ethylene terphthalate) (PET) with a Tm of about 220° C. The sheath may comprise an amorphous polyester, with a Tg of about 70° C. Accordingly, the amorphous polyester may provide bonding when the system is heated above the Tg, and the other fibers do not themselves experience melting.

According to embodiments of the present invention, a backing or carrier layer may be disposed within the enclosure and the materials or preferred fibers blown into the enclosure to form a preform which are supported by the backing layer. The backing layer may be included to provide specific properties to the decoupler, such as additional acoustic impedance, a finished outer surface, a disposable cover, etc. The backing layer may be any of various types of materials. For example, the layer may comprise an acoustic web of material. However, other types of materials that may be utilized as a layer include, but are not limited to, scrim material, carpeting, shoddy, fiber batting, foam, etc. With respect to the layer, such layer is preferably porous, in order that air may flow through it as the preform is being formed and heated into a finished decoupler configuration. The backing layer may further function as a carrier layer to facilitate transporting the preform from the enclosure to the forming mold.

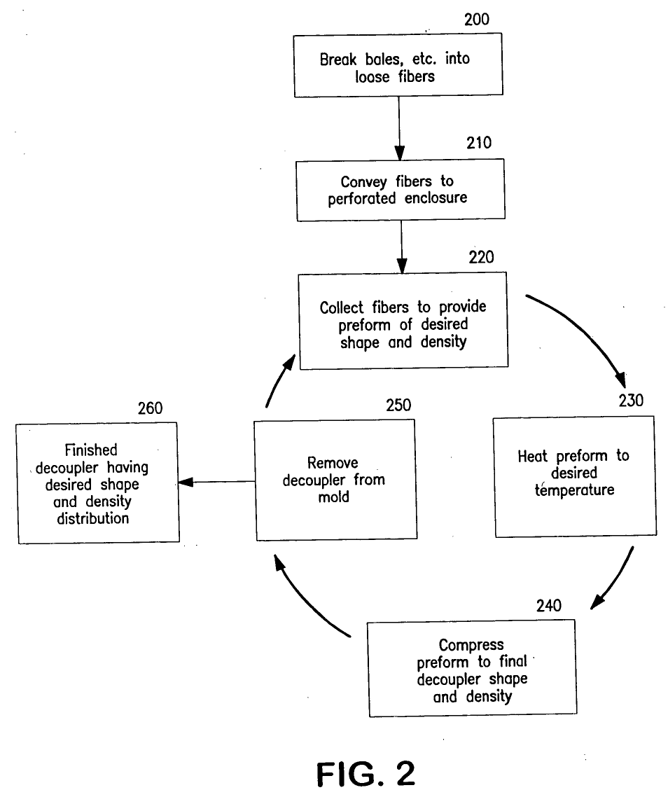

Referring now to FIG. 2, a method of manufacturing an article of controlled density, such as a decoupler, is illustrated in block form, according to embodiments of the present invention, which includes the steps of: preparing fibers by breaking bales, etc. of fibers into a loose condition (Block 200); conveying the loose fibers to an enclosure (Block 210); collecting the loose fibers to form a preform having a desired shape and density profile (Block 220); heating the preform toga temperature such that adjacent fibers upon cooling bond to one another (Block 230); forming the preform via a mold into a predetermined three-dimensional decoupler configuration having a desired density distribution and shape (Block 240) and removing the decoupler from the mold (Block 250). Upon cooling, a three-dimensional decoupler configuration is provided having the desired shape and density distribution (Block 260) wherein the bonding of adjacent fibers to one another provides shape retention of the molded configuration. The process shown in FIG. 2 is illustrated as being carried out in a repetitive manner by being shown as a circle to which a preferably fibrous preform is conveyed and from which finished decouplers exit. Thus, the molds in the, preferably, rotary process of the present invention are moved from station to station to carry out the various steps of the process.

According to embodiments of the present invention, the various steps of the operations illustrated in FIGS. 1 and 2 may be performed out of the illustrated order. For example, acoustic properties of one or more portions of a vehicle passenger compartment may be performed well in advance of the remaining steps of FIGS. 1 and 2. Furthermore, operations represented by various blocks may be performed substantially simultaneously. For example, a preform may be heated and formed to shape (Blocks 230, 240) at substantially the same or different times.

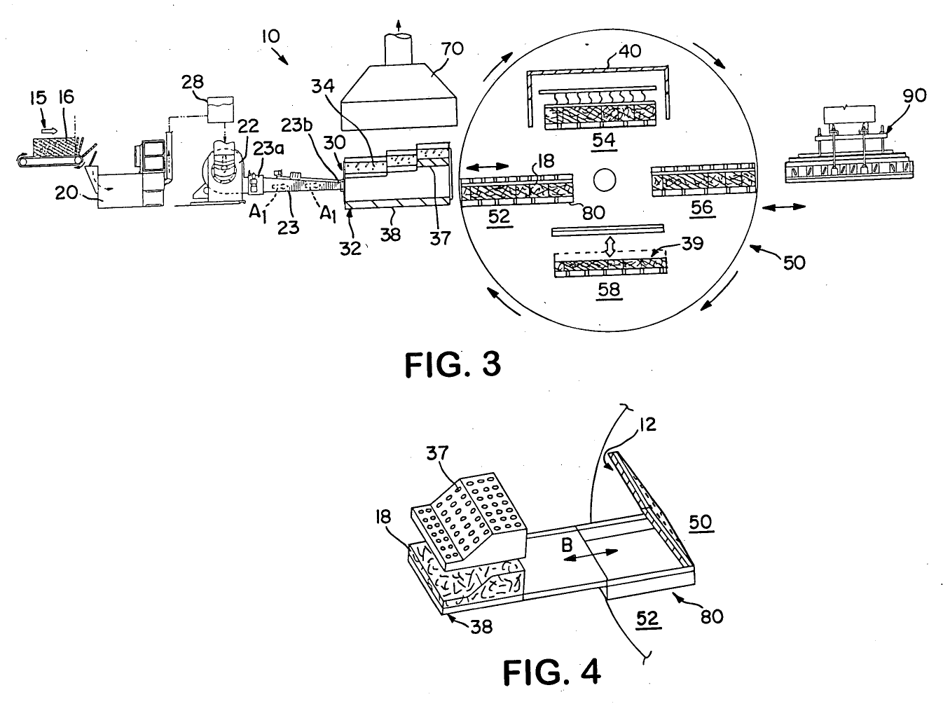

Referring now to FIG. 3, a preferred system 10 for manufacturing articles having controlled density, such as decouplers for vehicle interior trim components, according to embodiments of the present invention, is illustrated. The illustrated system 10 includes a fiber bale breaking station 15 where bales of fiber 16 are broken into smaller sections and then loaded into a fiber preparation station 20. Fiber preparation station 20 is configured to release the fibers from a generally compressed configuration (caused by being bundled) to an open, loose configuration and then to supply the loose fibers to a blower 22. Various types of devices may be utilized to implement the function of the fiber preparation station 20. For example, sets of rotating teeth or spikes may be utilized to open the fibers, as would be understood by those skilled in the art. One or more centrifugal (or other types) of fans may be provided to supply the open fibers to blower 22 or an equivalent movement source.

In connection with this step of the process (debating) it may be preferred to include a controlled amount of moisture, via misting, and/or an antistat and/or the use of deionized air to aid in preventing the fibers from reverting to a compacted state prior to introduction into the mold. An accumulator 28 may preferably be utilized to feed the blower 22. The accumulator may preferably include a photoelectric detector (not shown) to control the amount of fibers remaining in the accumulator for introduction into the enclosure.

Blower 22 is configured to blow the loose fibers into an enclosure 30 to form a preform 18 having the shape of the enclosure. In the illustrated embodiment, blower 22 and enclosure 30 are in fluid communication via duct 23. Flow of fibers through the duct 23 and into the enclosure 30 via the airstream is indicated by arrows A,.

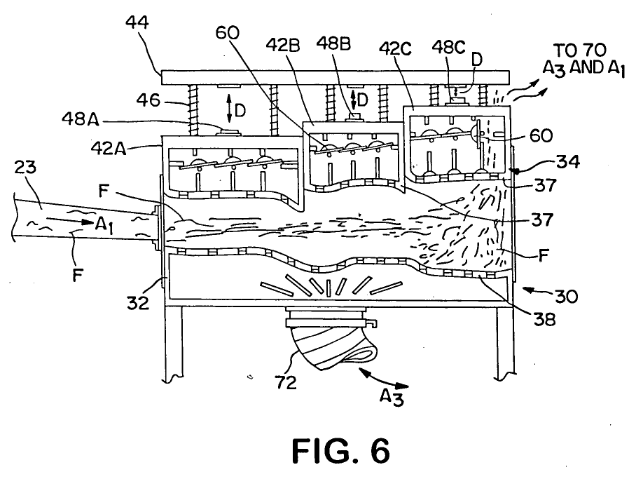

As will be described below, the enclosure 30 may have one or more perforated upper panels (37, see FIGS. 4 and 6) and panels (60, FIG. 6) that are moveably attached to the enclosure 30 so as to selectively expose the perforated panels 37, and thereby control the preform fiber density by allowing air to flow out of the enclosure through the exposed perforated portion causing more fibers to collect in an area as the pressure in that area increases. The illustrated enclosure 30 is defined by a base 32 and a movable upper portion 34.

The illustrated system 10 also includes an indexing apparatus 50 (shown not to scale and rotated 90° from ^{the} horizontal for clarity) which conveys a series of molds 80 from station to station to form the preform into a decoupler. As indicated in FIG. 3, the indexing device may include station 52 to receive the preform from the enclosure and support the preform in a forming mold 80, station 54 which includes oven 40 for heating (e.g., via heated air, infrared radiation, etc.) the preform 18 (after being removed from the enclosure 30 and placed into the mold 80) to a temperature such that adjacent fibers upon cooling bond to one another, station 56 for forming the preform into a preferred shape as a decoupler, and station 58 where the decoupler is removed from the mold 80 and the mold readied for the next preform. Other indexing apparatus as known in the art, including but not limited to, shuttle tables, robots, mold manipulators and over-and-under lines may also be used to convey the preform from station to station.

In a preferred embodiment, a series of molds 80 (shown in an open configuration to receive the preform 18 in FIG. 4) are conveyed on a rotary table 50 which stops at each of the stations (52,54,56,58) at which point (i) the preform is shuttled to the mold (52), (ii) the mold 80 containing the preform is shuttled to (or through) the oven 40 (54),(iii) the mold is shuttled into a press (90) for forming the heated preform 18 into a predetermined three-dimensional decoupler configuration 39 by closing over the preform and compressing it to shape (56), and (iv) the mold is opened for removal of the decoupler 39 (58). Various temperatures will be required to bond various different types of fibers. For example, for shoddy fibers, the temperature required to allow fibers to bond is about 390° F. Upon cooling, the bonding of the adjacent fibers to one another causes the decoupler to essentially retain the shape of the mold. As noted above, this is preferably accomplished by the use of an amorphous polymer component that itself does not have a Tₘ.

FIG. 4 is a partial perspective view of a preform 18 being transferred from the enclosure 30 to the mold 80. The arrow B indicates the direction of the shuttle to move the preform 18 to the indexing apparatus 50. The enclosure 30 has been opened after forming the preform and the mold 80 is open ready to receive the preform for further processing. The preform 18 may be transferred by any number of means, including but not limited to, shuttle conveyor, a backing layer, manually, etc. The enclosure comprises a top 34 having one or more perforated panels 37 and a base 32 comprising one or more perforated panels 38 to allow air to be blow or drawn through and deposit fibers against the enclosure 30, filling the enclosure and forming the preform 18. The mold 80 also preferably comprises perforated sections such that hot air may be drawn or blown through for adequate heating in the oven 40. As shown in FIG. 4 the mold 80 may be of a clam-shell variety, or may be of two separate sections, such that upon placement in a press 90 (station 56) the mold may be further closed to reduce the thickness of the preform 18 to that desired for the final decoupler 39 configuration. Further, as shown in FIG. 4 the shape of the enclosure 30 and mold 80 may have different contours such that more compression or reduction in thickness may take place in one area of the preform than another area to provide additional acoustic impedance in that corresponding area of the finished decoupler 39. Also, as shown in FIG. 4, the mold 80 may contain an interior trim component 12 mounted on one of its' surfaces which may be heated and molded such that the finished decoupler is mounted to the component (e.g. a section of carpet) upon demolding.

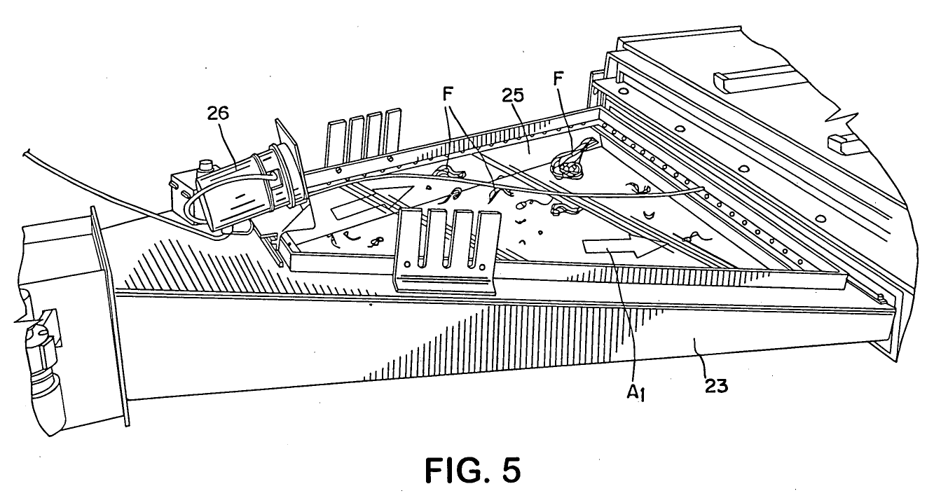

FIG. 5 is a partial perspective view of duct 23. The illustrated duct 23 has a transparent window 25 that allows an operator to view fibers F being blown into the mold 30. A pressure control gauge 26, preferably a Photohelic® gauge from Terra Universal or the like, is mounted on the duct 23 and is configured to measure the pressure within the duct 23 and/or within the enclosure 30. When the pressure reaches a preset limit, a signal is sent to a solenoid which controls the action of the moveable panels 60 which are then selectively opened or closed to expose the next perforated section 37. (See FIG. 6)

FIG. 6 is a side view illustrating the base 32 and movable upper portion 34 in spaced relationship to form enclosure 30. The base portion 32 of the enclosure 30 has an upper surface configured to the shape desired for the decoupler which is to be formed therein and may be flat or of nearly any complex geometry. Transparent panels preferably surround the enclosure 30 and allow observation of the forming of the preform (shown bring partially formed) and containment of the fibers or other materials. In the illustrated embodiment, the lid or upper portion 34 of the enclosure 30 comprises 3 sections, 42A, 42B and 42C which may be independently adjustable to form various cross-sectional thicknesses in different areas of the preform 18. The upper portion 34 of the enclosure 30 may include any number of sections to create the desired top surface of the preform 18 when placed into the appropriate spaced relationship with base portion 32. For instance, independently adjustable lid sections 42A, 42B and 42C may be spaced from an enclosure top plate 44 by coil springs 46 or the like. FIG. 6 further illustrates an airstream A₁ conveying fibers F via duct 23 into enclosure 30. The fibers flow into the spaced apart enclosure portions and are collected at a position where the airstream exits and flows to the hood (70, not shown). A plurality of movable panels 60 overlie upper perforated sections 37 of the enclosure upper portions 42A, 42B, 42C. As illustrated, the panels 60 may rotate to expose the perforated section 37 allowing air to flow through that area of the enclosure and out to the hood 70. Alternatively, the panels 60 may be moved across the enclosure in a fore/aft direction. In addition, the panels 60 may alternatively be lifted, hinged, slid or otherwise displaced, to expose areas of the perforated section 37 where greater fiber density is desired. For lower density areas, the panels are moved more quickly to reduce the collection of fibers in that area of the preform. In the illustrated embodiment, the panels 60 are preferably louvers that open individually by rotating to expose a perforated section 37 of the enclosure upper portion 42C as shown.

Alternatively, rather than exposing the perforated areas sequentially and continuously, it is contemplated herein that after exposure, selected regions of the perforated portions may be closed. In this manner, one may more reliably develop distinct density boundaries within the preform composition. For example, the panels 60 may selectively be opened and closed, across the perforated sections 37 of the enclosure 30 to selectively collect fibers at such locations. This preferably includes panels that are hinged on one edge which extend over such selected area. The panels can therefore be hingedly moved to expose the perforations, and the time period for opening may be conveniently controlled by an associated processor or programmable logic controller (PLC). The opening and closing may be the same across the entire cross section of the enclosure, or timed differently, to thereby provide different density profiles in the preform.

In FIG. 6, fibers are shown being blown into the enclosure 30 and a panel 60 is rotated to expose perforated section 37. Air blown into the enclosure 30 with the fibers exits the mold via perforated section 37. Fiber density within the mold is controlled locally by the rate at which the panels or louvers 60 are moved which is proportional to the pressure achieved as fibers are blown into the enclosure 30 and by the concentration of fibers in the air as it is being conveyed. For greater fiber density in a particular portion of the enclosure 30, the duration that the perforated section 37 is exposed is longer than for portions of the enclosure where less fiber density is desired. The duration of exposure of the perforated portion 37 is proportional to the amount of pressure that is created within the enclosure as fibers are blown therein. A photohelic gauge 26 as shown in FIG. 5 is connected to a solenoid which operates the louver 60 to open and close each panel, or louver in this case, sequentially to form a preform having different areas or sections of different fiber density.

Alternatively, it should be recognized that the lower portion 32 of the enclosure 30 may also comprise perforated panels 38 which contact the lower portion of the preform such that one could draw a vacuum or blow air to assist in deposition of the fibers at such locations. For example, in the case of a contoured preform, with areas which are relatively more difficult to fill, the use of vacuum will assist in filling a thick and contoured preform geometry. Thus, in FIG. 6, air may be conveyed to the enclosure 30 by pressure, vacuum and combinations thereof and be exhausted from the mold through perforated sections 37 in the upper enclosure sections (42A, 42B, 42C) as well as through perforated panels 38 and duct 72 in the lower enclosure section 32.

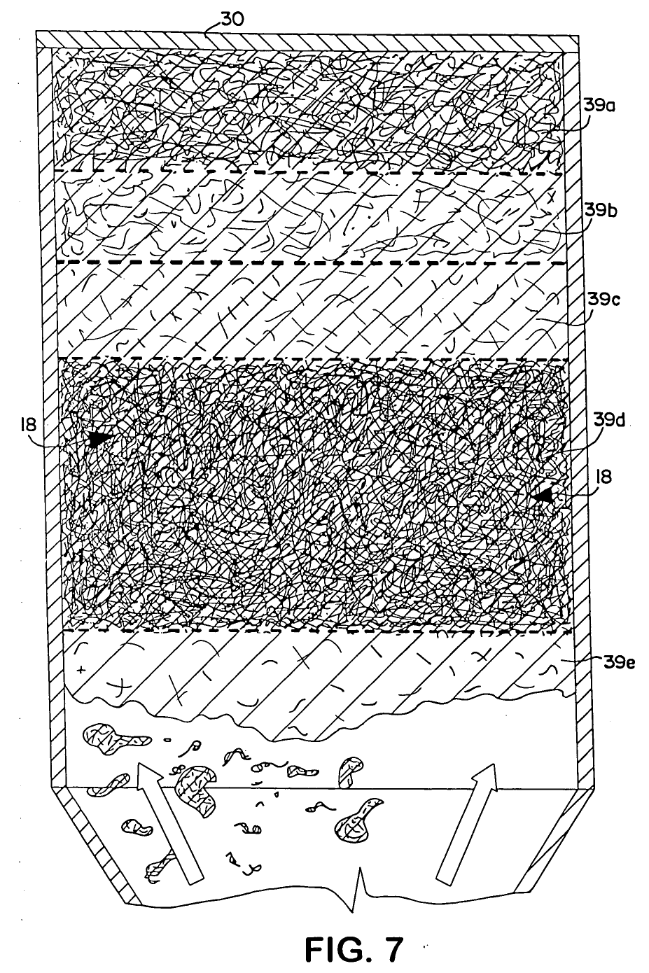

FIG. 7 is a top plan view of enclosure 30 with the upper portion 34 removed for clarity and illustrating a preform 18 substantially formed therein. The illustrated preform 18 has five portions or sections 39a-39e with respective different fiber densities. Section 39e is still being formed (i.e., fibers as the most preferred material are still being blown into the enclosure 30). The fiber density of each portion was achieved by controlling the rate of removal of panels 60 at the location of each preform section as described above. While illustrated here as being comprised of rectangular areas having different fiber densities, the preform 18 may be formed with selected areas of nearly any shape (for instance, round, triangular, hexagonal, etc.) having different fiber densities by configuring the moveable panels 60 to be of a corresponding shape, such that upon removal the airflow emanating from the exposed perforated section 37 causes more fibers to be collected in that area.

For example, one may convey the preferred fibers into an enclosure to form a preform having a shape of the enclosure, wherein the enclosure has a panel containing one or a plurality of movable portions relative to the enclosure so as to selectively expose portions of the enclosure. Such movable portion may include, e.g. a plurality of round movable portions (e.g. iris or shutter-like) that selectively open and close across the surface of the panel thereby selectively controlling the air flow. In such opening, preferably, one may include mesh or other related structure to regulate the amount of air that blows through, and the amount of material or fiber retained in the enclosure.

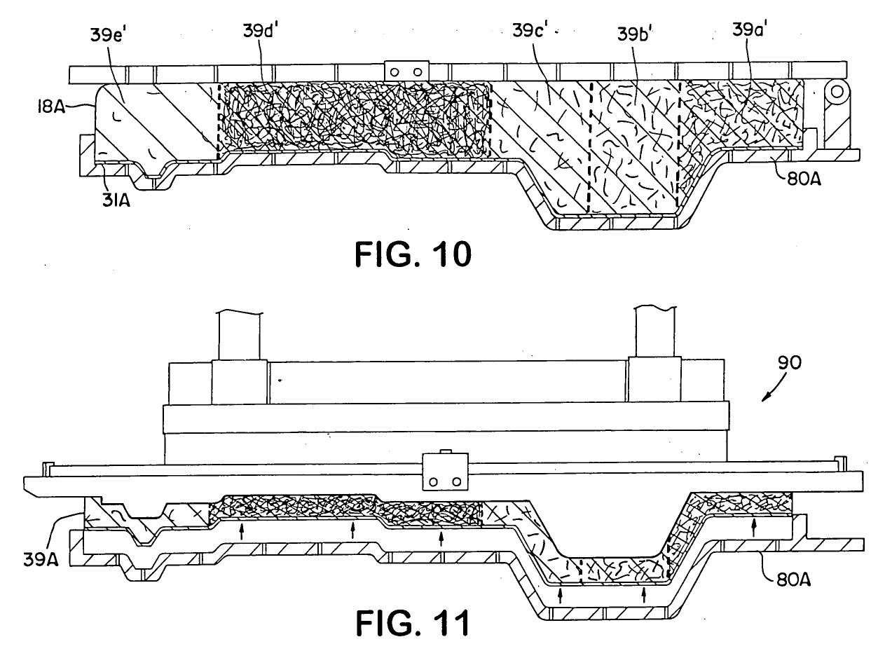

Although illustrated herein as a rectangle, enclosure 30 may have various shapes, sizes and contours which may correspond to one or more performs. For instance, a large preform may be formed and cut to shape to provide multiple performs. In other words, more than one perform may be formed in the enclosure at one time. In addition, baffles and cavities may be utilized as part of the enclosure to achieve complex cross-sectional configurations and shapes. For example, each of the illustrated sections 39a-39e of the illustrated decoupler 39 (see FIG. 10) could have different cross-sectional dimensions (e.g., different heights, etc.) formed by the outer walls of the enclosure.

Further, in a particularly preferred embodiment, a contoured preform of varied cross-section may be locally reduced in height in the molding process to further densify specific areas of the preform requiring sound attenuation. This height reduction may vary depending upon the acoustical requirements and decoupler density at a desired location in the vehicle.

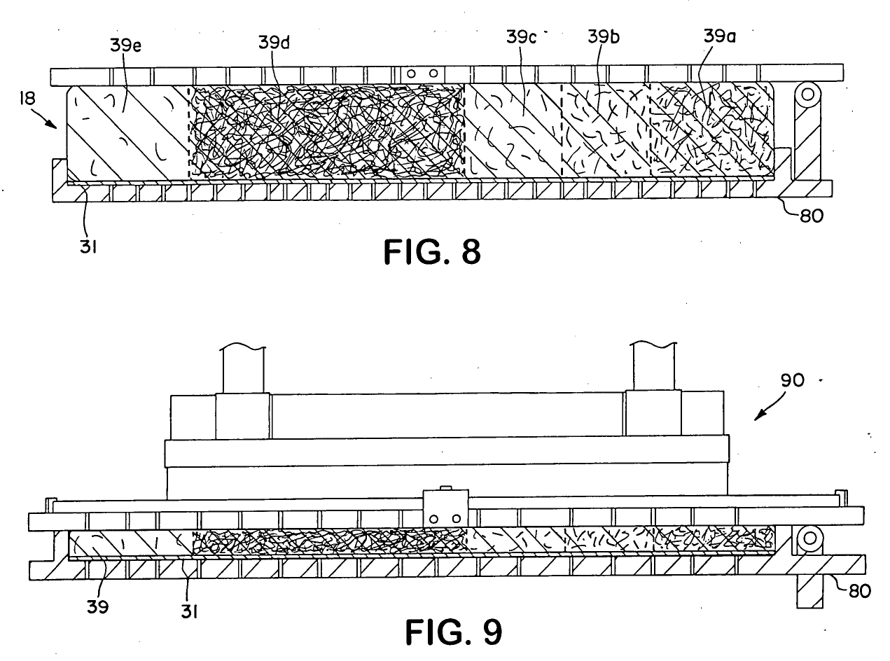

Referring now to FIG. 8, the preform 18 of FIG. 7 has been placed into the mold 80 and is being transported for subsequent processing using the indexing apparatus 50 of the present invention. As shown the preform 18 is carried by a backing layer 31 for ease of handling. The mold 80 is indexed to the oven 40 in station 54 (FIG. 3) for heating to allow adjacent fibers upon cooling to bond to each other.

The heated preform 18 is then moved to station 56 (FIG. 3) where the mold 80 is shuttled into a frame 90 for final forming. FIGS. 8-9 illustrate a mold 80 configured to mold the heated preform 18 into a substantially rectangular, compressed decoupler configuration 39 having an essentially constant cross-section. In the illustrated embodiment, sections 39a-39e of decoupler 39 have different respective densities, but the same compressed height after molding. Once removed from mold 80 and cooled (see FIG. 9), the decoupler 39 may be subjected to various trimming and/or other finishing operations known to those skilled in the art.

FIG. 10-11 illustrate a mold 80A configured to compress a preform 18A having a substantially non-rectangular configuration into a contoured configuration 39A with a substantially constant cross-sectional dimension. FIG. 10 illustrates the preform in the mold 80A prior to being compressed, and FIG. 11 illustrates the final contoured shape of the decoupler 39A being removed from the mold 80A. In the illustrated embodiment of FIGS. 11, the decoupler 39A has a contoured configuration and sections 39a′-39e′ have different respective densities but the same height after molding.

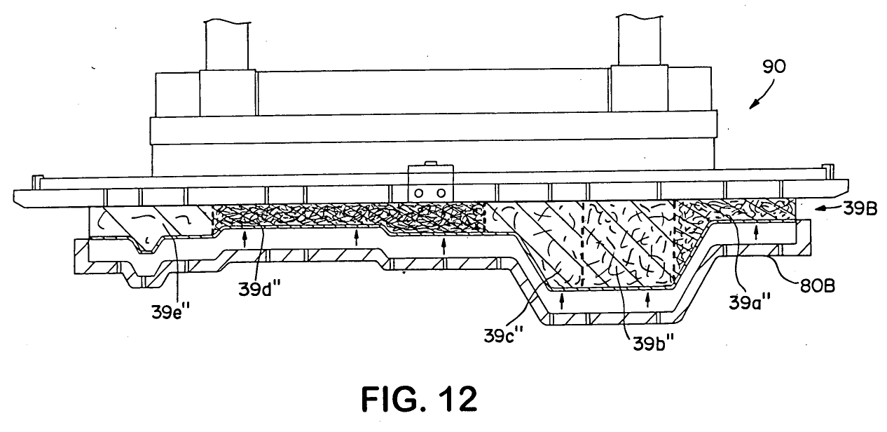

FIG. 12 illustrates a decoupler 39B being removed from a mold 50B. The mold has been configured to mold a preform having a substantially non-rectangular configuration into a compressed configuration 39B with non-constant cross-sectional dimensions. In the illustrated embodiment of FIGS. 12, the decoupler 39B has a contoured configuration and sections 39a″-39e″ have different respective densities and different respective heights after molding to provide a wide range of acoustic impedance. This provides a wide range of density combinations to provide sound attenuation at various specific areas of an interior trim component. Particularly, the method and apparatus of the present invention provides means to manufacture articles having a plurality of specific areas of controlled density.

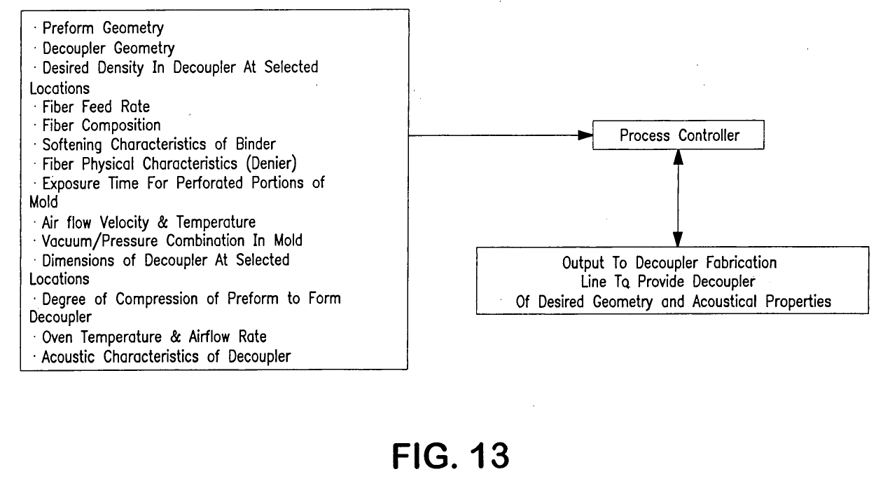

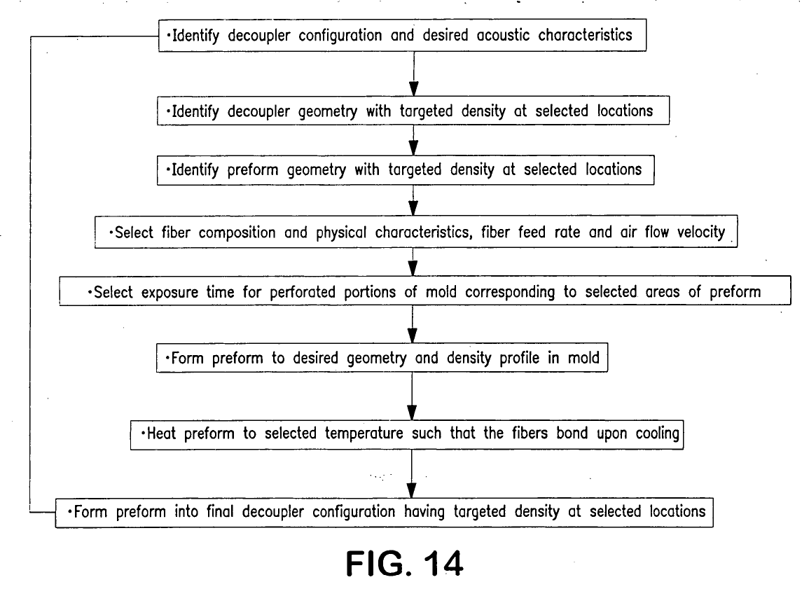

FIG. 13 illustrates that the present invention may be automated through a process controller (computer) which has inputs of the indicated variables, such as preform geometry, decoupler geometry, desired density in decoupler at selected locations, material or fiber feed rate, material or fiber composition, softening characteristics of the binder, fiber denier, exposure time for perforated portions of the enclosure, air flow velocity and temperature, vacuum/pressure combination in the enclosure, cycle time for the indexing table, dimensions of the decoupler at selected locations, degree of compression of the preform to form the decoupler, oven temperature and air flow rate and the desired acoustic characteristics of the decoupler, etc. The inputting of this information is then evaluated and outputted to the decoupler fabrication line to provide a preform and/or decoupler of a desired density, geometry and/or acoustical properties.

FIG. 18 illustrates in exemplary embodiment the process control features which may take place using the process controller of the present invention. For example, one may identify a decoupler configuration with desired acoustic characteristics at selected locations. The processor then compares this input with information stored in a machine readable memory which identifies a density and thickness that corresponds to the desired acoustic characteristics at such selected locations. The controller then determines a suitable preform geometry with density requirements at the selected location to achieve the decoupler acoustic requirements. The processor then selects the appropriate process inputs of the system to create such preform that provides the desired decoupler. This includes selecting material or the preferred fiber composition and physical characteristics (e.g., denier) and material or fiber feed rate and air flow velocity to deliver to the system enclosure. In addition, the processor may select and control the exposure time for perforated portions of the enclosure corresponding to the areas of the preform that must be formed with a selected density. The processor then selects and controls the formation of the preform including the density profile of the preform that is desired. The processor also then selects and controls the temperature of the oven that heats the preform to a selected temperature such that the materials or fibers bond upon cooling. The processor selects and controls the cycle time for the rotary table and compression in the mold that is utilized to form the preform into the final decoupler.

Accordingly, in connection with the above, the present invention also contemplates a machine-readable medium whose contents cause a system to perform a method of forming a decoupler for a vehicle interior trim component. The medium acts to store a desired acoustical characteristics of a decoupler configuration in the medium and to store processing variables required to provide acoustical characteristics of a decoupler. The medium then selects certain processing variables required to form the decoupler with the desired acoustical characteristics. The medium then outputs the processing variables to the system to perform the method of forming the decoupler.

It will be appreciated that the functionality described for the embodiments of the invention may be implemented by using hardware, software or combination of hardware and software. If implemented by software, a processor and machine-readable medium are required. The processor may be of any type of processor capable of providing the speed and functionality required by the embodiments of the invention. For example, the processor could be a processor from the Pentium® family of processors made by Intel Corporation, or the family of processors made by Motorola. Machine-readable media include any media capable of storing instructions adapted to be executed by a processor. Some examples of such media include, but are not limited to, read-only memory (ROM), random-access memory (RAM), programmable ROM (PROM), erasable programmable ROM (EPROM), electronically erasable programmable ROM (EEPROM), dynamic RAM (DRAM), magnetic disk (e.g., floppy disk and hard drive), optical disk (e.g. CD-ROM), and any other device that can store digital information. In one embodiment, the instructions are stored on the medium in a compressed and/or encrypted format.

Thus the invention provides a means to manufacture articles having controlled density, such as acoustic decouplers for use in motor vehicles, which may be formed into complex configurations and provide different levels of sound attenuation in various areas of the decoupler by varying both the density and the cross-sectional thickness of the decoupler, locally. Further, the decoupler may be attached to a trim component as part of the molding process to provide a finished product ready for installation in the vehicle, having a configuration matching an area which requires specific sound attenuation.

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method of manufacturing a decoupler for a vehicle interior trim component, comprising:
conveying materials into an enclosure to form a preform having a shape of the enclosure, wherein the enclosure has a perforated portion and at least one panel movable relative to the enclosure so as to selectively expose portions of the perforated portion;
providing conveying apparatus, a plurality of stations, and a plurality of molds wherein said apparatus conveys said plurality of molds from station to station to form said preform into said decoupler, wherein said stations sequentially;
receive said preform from said enclosure into said mold;
heat said preform in said mold to a temperature such that adjacent materials may bond to one another upon cooling; and
form said heated preform in said mold into a predetermined three-dimensional decoupler.

2. The method of claim 1 wherein the conveying apparatus includes an indexing line wherein said apparatus selectively starts and stops with respect to each station.

3. The method of claim 2 wherein the indexing line comprises a rotary table.

4. The method of claim 1, wherein the molds and/or the enclosure has a contoured shape.

5. The method of claim 1 wherein the materials comprise thermoplastic material, thermoset material, fibrous material, foam, woven material, nonwoven material, fiber of any type, and combinations thereof.

6. The method of claim 5, wherein the fibers may comprise any of natural fibers, synthetic fibers, recycled fibers, bicomponent fibers and blends thereof.

7. The method of claim 6, wherein the fibers comprise shoddy fibers.

8. The method of claim 1, wherein the materials are conveyed into-the enclosure in a substantially loose state.

9. The method of claim 1, wherein a carrier layer is disposed within the enclosure and wherein the preform is supported by the carrier layer.

10. The method of claim 9, wherein the carrier layer comprises an acoustic web of material, scrim or contoured trim piece.

11. The method of claim 9, wherein the carrier layer comprises scrim material.

12. The method of claim 1, wherein the materials are conveyed-into the enclosure from more than one direction.

13. The method of claim 1, wherein the materials are conveyed into the enclosure so as to form a preform having first and second portions said portions having different respective densities.

14. The method of claim 13, wherein the materials are conveyed into the enclosure so as to form a preform having first and second portions said portions having different respective cross-sectional dimensions, and wherein the forming step comprises forming the heated preform into a predetermined three-dimensional decoupler configuration.

15. The method of claim 13, wherein the materials are conveyed into the enclosure so as to form a preform having first and second portions said portions having substantially the same respective cross-sectional dimensions, and wherein the forming step comprises forming the heated preform into a predetermined three-dimensional decoupler configuration.

16. The method of claim 1, wherein the conveying of materials into the enclosure includes the adjusting of the rate of movement of the at least one panel to adjust density in identified portions of the decoupler requiring enhanced sound attenuation.

17. The method of claim 1, further comprising the ascertaining of acoustic properties of a vehicle passenger compartment to identify portions of the decoupler requiring enhanced sound attenuation.

18. The method of claim 17, wherein the ascertaining of acoustic properties of the vehicle passenger compartment comprises identifing portions of the decoupler at which sound within a predetermined frequency range is directed at an intensity level that exceeds a threshold intensity level.

19. The method of claim 17, wherein the ascertaining of acoustic properties of the vehicle passenger compartment comprises generating a sound intensity map of at least a portion of the vehicle passenger compartment.

20. The method of claim 1 wherein the materials are heated as they are conveyed into said enclosure.

21. The method of claim 1 including a plurality of panels movable relative to the enclosure.

22. The method of claim 20 wherein said panels are hingedly moveable and selectively opened and closed.

23. The method of claim 1 wherein said enclosure includes a partition.

24. The method of claim 1 wherein the density of the preform may be varied as the at least one panel is moved to expose the perforated portion of the enclosure.

25. The method of claim 1 wherein the step of heating the preform to a temperature. such that adjacent materials may bond to one another upon cooling comprises supplying the preform with materials comprising an amorphous polymer and a crystalline polymer wherein the amorphous polymer is heated above its glass transition temperature (Tg) and the crystalline polymer is heated to a temperature below its melting point (Tm).

26. A system for manufacturing a preform comprising:
an enclosure comprising a perforated portion and at least one panel movable relative to the enclosure so as to selectively expose portions of the perforated portion;
a feeder configured to introduce materials into the enclosure to form a preform having a shape of the enclosure wherein the density of the preform within the enclosure may be varied by moving the at least one panel to expose the perforated portion of the enclosure as materials are blown into the enclosure;
a conveying apparatus including a plurality of molds; wherein said conveying apparatus further comprises a plurality of stations which in sequence;
receive said preform from said enclosure into one of said plurality of molds;
heat said preform in said one of a plurality of molds to a temperature such that adjacent materials may bond to one another upon cooling; and
form said heated preform in said one of said plurality of molds into a predetermined three-dimensional decoupler.

27. The method of claim 26 wherein the conveying apparatus comprises an indexing line wherein said apparatus selectively starts and stops with respect to each station.

28. The method of claim 27 wherein the indexing line comprises a rotary table.

29. The system of claim 26 wherein the system includes a plurality of panels movable relative to the enclosure.

30. The system of claim 29 wherein said panels are hingedly movable and capable of being selectively opened and closed.

31. The system of claim 26 wherein the materials comprise thermoplastic material, thermoset material, fibrous material, foam, woven material, nonwoven material, fiber of any type, and combinations thereof.

32. The system of claim 26, further including a bale cutter to provide fibers to said feeder.

33. The system of claim 26 further including a process controller wherein said process controller includes inputting of processing variables and said process controller outputs control parameters to said system to provide a desired geometry and density for said preform.

34. The system of claim 26 further including a process controller wherein said process controller includes inputting of processing variables and said process controller outputs control parameters to said system to provide a desired geometry and density for said decoupler.

35. The system of claim 26 further including a machine-readable medium whose contents causes the system to perform a method of forming a decoupler for a vehicle interior trim component comprising;
storing desired acoustical characteristics of a decoupler configuration in said medium;
storing processing variables required to provide said desired acoustical characteristics of said decoupler;
selecting at least one processing variable required to form said decoupler with said desired acoustical characteristics;
outputting said at least one processing variable to said system to perform said method of forming said decoupler.

36. A method of manufacturing an article of controlled density, comprising:
conveying materials into an enclosure to form a preform having a shape of the enclosure, wherein the enclosure has a panel containing one or a plurality of movable portions relative to the enclosure so as to selectively expose portions of the enclosure, wherein the density of the preform may be varied as the at least one or plurality of movable portions are moved to expose a portion of the enclosure;
providing conveying apparatus, a plurality of stations, and a plurality of molds wherein said apparatus conveys said plurality of molds from station to station to form said preform into said article, wherein said stations sequentially;
receive said preform from said enclosure into said mold;
heat the preform in said mold to a temperature such that adjacent materials may bond to one another upon cooling; and
form the heated preform in said mold into said article.

37. The method of claim 36 wherein the materials comprise thermoplastic material, thermoset material, fibrous material, foam, woven material, nonwoven material, fiber of any type, and combinations thereof.

38. The method of claim 36 wherein said step of conveying materials includes introducing said materials in a substantially loose state by blowing said materials into said enclosure with an air stream, and said one or plurality of moveable portions upon moving defines an opening in said panel to expose a portion of the enclosure, wherein said openings further include a structure to regulate the amount of air that blows through and the amount of material retained in the enclosure.

39. The method of claim 36 wherein vacuum is included to convey said materials into said enclosure to form said preform.

40. The method of claim 38 wherein said step of conveying materials includes introducing said materials in a substantially loose state by blowing said materials into said enclosure with an air stream and applying a vacuum to convey said materials.

41. A rotary indexing apparatus for forming a preform into a decoupler, the apparatus comprising;
an indexing table comprising a plurality of mold stations and a plurality of process operations wherein each mold station is operatively engaged to a selected process operation;
a mold located at each mold station;
a shuttle apparatus for moving said mold from said mold station to said selected process operation;
wherein said table indexes said mold in said mold station sequentially to said selected process operation to form said decoupler, and wherein said process operations comprise:
receiving said preform into said mold;
heating the preform in said mold to a temperature such that adjacent materials may bond to one another upon cooling;
forming the heated preform in said mold into a predetermined decoupler configuration; and
removing said decoupler from said mold.
